(19) United States
(12) Patent Application Publication
(10) Pub. No.: US 2026/0333443 A1
(43) Pub. Date: Oct. 22, 2026

(54) FREQUENCY HOPPING CONSIDERATIONS WITH MULTIPLE PHYSICAL RANDOM ACCESS CHANNEL TRANSMISSIONS

(71) Applicant: QUALCOMM Incorporated, San Diego, CA (US)

(72) Inventors: Hung Dinh LY, San Diego, CA (US); Kexin XIAO, Shanghai (CN)

(21) Appl. No.: 19/112,204

(22) PCT Filed: Nov. 14, 2022
(86) PCT No.: PCT/CN2022/131649

§ 371 Date: Mar. 14, 2025

(51) Int. Cl. H04W 74/0833; H04L 5/00

(52) U.S. Cl. CPC H04W 74/0833; H04L 5/001

(57) ABSTRACT

Certain aspects of the present disclosure provide techniques for using frequency hopping when transmitting a physical random access channel (PRACH) message with repetition. An example method that may be performed by a user equipment (UE) includes receiving configuration information indicating one or more parameters configuring the UE for physical random access channel (PRACH) message transmissions with repetition; determining whether to use frequency hopping when transmitting repetitions of a PRACH message, based on a value of at least one of the parameters; and transmitting repetitions of the PRACH message in accordance with the determination.

### BACKGROUND

### Field of the Disclosure

Aspects of the present disclosure relate to wireless communications, and more particularly, to techniques for using frequency hopping when transmitting a physical random access channel (PRACH) message with repetition.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving configuration information indicating one or more parameters configuring the UE for physical random access channel (PRACH) message transmissions with repetition; determining whether to use frequency hopping when transmitting repetitions of a PRACH message, based on a value of at least one of the parameters; and transmitting repetitions of the PRACH message in accordance with the determination.

Another aspect provides a method for wireless communications by a UE. The method includes receiving configuration information that maps repetitions of a PRACH message to random access channel (RACH) occasions (ROs); determining whether to skip, postpone, or transmit a repetition that is mapped to an invalid RO, based on whether the UE is configured to use frequency hopping when transmitting repetitions of a PRACH message; and transmitting repetitions of the PRACH message in accordance with the determination.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram illustrating an example four-step random access channel (RACH) procedure.

FIG. 6 depicts call flow diagram illustrating an example two-step RACH procedure.

FIG. 7 depicts an example timeline of physical random access channel (PRACH) transmission in a multi-beam system, according to aspects of the present disclosure.

FIG. 8 depicts an example timeline of an association pattern period, according to aspects of the present disclosure.

FIG. 9 is a graph depicting PRACH detection performance for a network entity receiving PRACH transmission repetitions with and without frequency hopping, in accordance with aspects of the present disclosure.

FIG. 10 depicts a process flow for communications in a network between a network entity and a user equipment (UE).

FIG. 11 depicts an example timeline of a UE transmitting repetitions of a PRACH message with frequency hopping with a single beam, in accordance with aspects of the present disclosure.

FIG. 12 depicts an example timeline of a UE transmitting repetitions of a PRACH message with frequency hopping with different beams, in accordance with aspects of the present disclosure.

FIG. 13 depicts a method for wireless communications.

FIG. 14 depicts a process flow for communications in a network between a network entity and a user equipment (UE).

FIG. 15 depicts an example timeline of a UE transmitting repetitions of a PRACH message with frequency hopping with a single beam, in accordance with aspects of the present disclosure.

FIG. 16 depicts the same example timeline shown in FIG. 15, except the transmission of the fourth repetition of the PRACH message is illustrated.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for transmitting a physical random access channel (PRACH) message with repetition.

When a UE is performing a PRACH procedure to access a network, the UE may be configured to transmit one or more of the messages of the PRACH procedure with repetition. That is, the UE may be configured to transmit a PRACH message repeatedly. The UE transmitting a PRACH message repeatedly improves the probability of a network entity (e.g., a base station (BS)) successfully receiving the PRACH message.

If multiple random access channel (RACH) occasions (ROs) are multiplexed in the frequency domain (i.e., multiple ROs occur in a same period on different frequencies), then a UE may use frequency hopping (FH) when transmitting repetitions of a PRACH message to further improve the probability of the network entity successfully receiving the PRACH message. Typical communications systems explicitly configure an additional parameter (e.g., in a system information block (SIB)) to enable FH for PRACH messages transmitted with repetition. In addition, an RO is sometimes invalid (e.g., due to a conflict with other transmissions at the same time on the same frequency), and a UE skips or postpones transmission of a PRACH message repetition mapped to the invalid RO.

According to aspects of the present disclosure, a UE may determine, based on one or more parameters configuring the UE for PRACH message transmissions with repetition without the network explicitly configuring an additional parameter, to enable frequency hopping for the PRACH message transmissions with repetition. In some aspects of the present disclosure, when a UE has a transmission of a PRACH message repetition mapped to an invalid RO, the UE may determine whether to skip, postpone, or transmit (e.g., in a valid RO that is multiplexed in the frequency domain with the invalid RO) the PRACH message repetition based on whether the UE is configured to use frequency hopping when transmitting repetitions of a PRACH message.

By enabling a UE to determine whether to enable frequency hopping for the PRACH message transmissions with repetition based on parameters configuring the UE for PRACH message transmissions with repetition, the probability of a network entity receiving the PRACH message may be improved, which may improve the reliability of the UE successfully performing the PRACH procedure with the network entity. In addition, transmission resources are conserved, because the network does not transmit the explicitly configured parameter to enable the FH for the UE performing the PRACH procedure. Enabling a UE to determine whether to skip, postpone, or transmit a PRACH message repetition based on whether the UE is configured to use frequency hopping may enable the UE to transmit a PRACH message repetition earlier (by not postponing the repetition) and improve the probability of a network entity receiving the PRACH message (by not skipping the repetition). Transmitting the repetition earlier may improve (e.g., reduce) latency and improve the reliability of communications by the UE.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

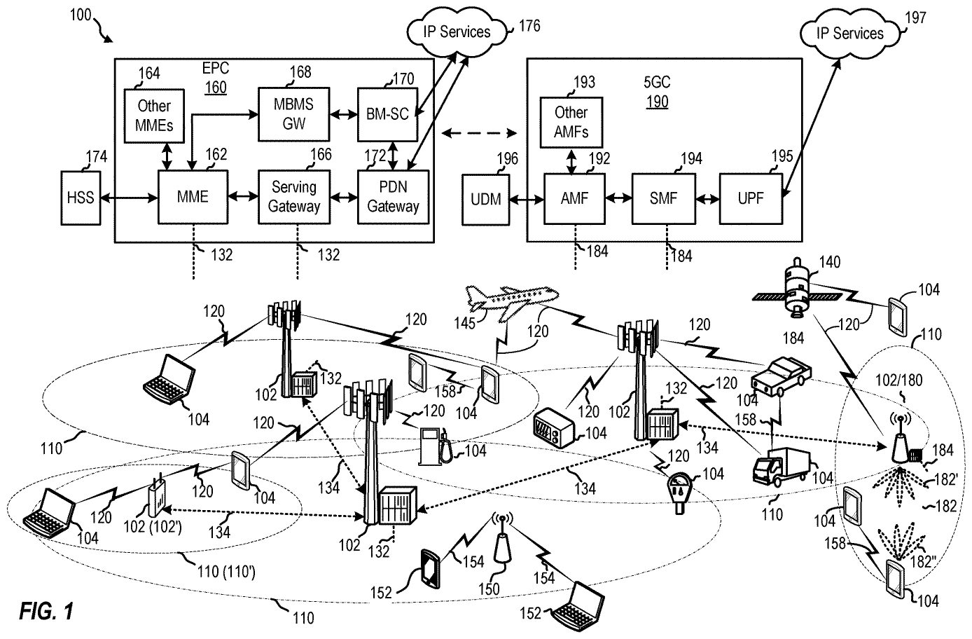

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

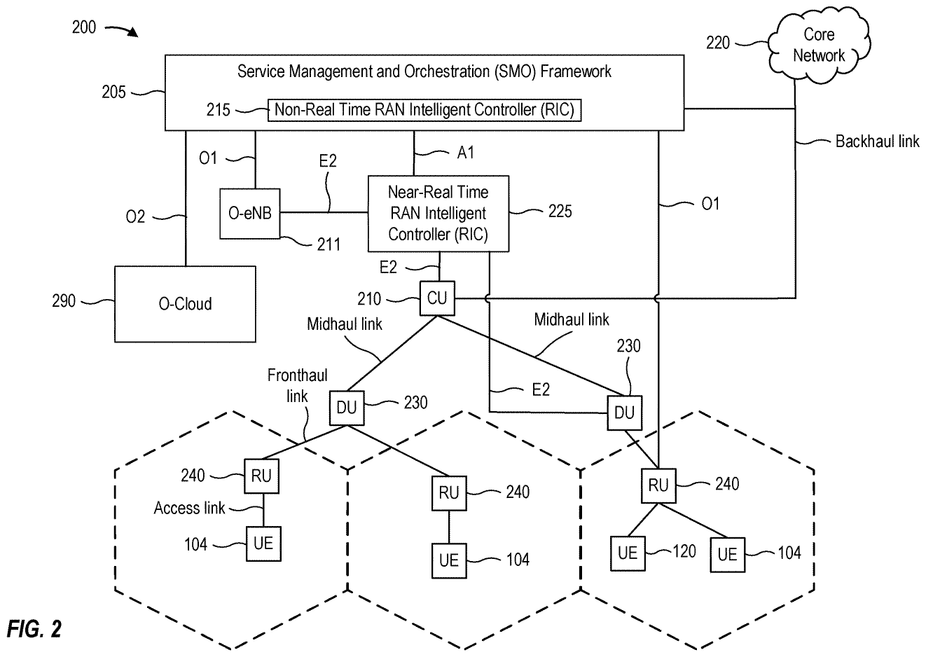

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

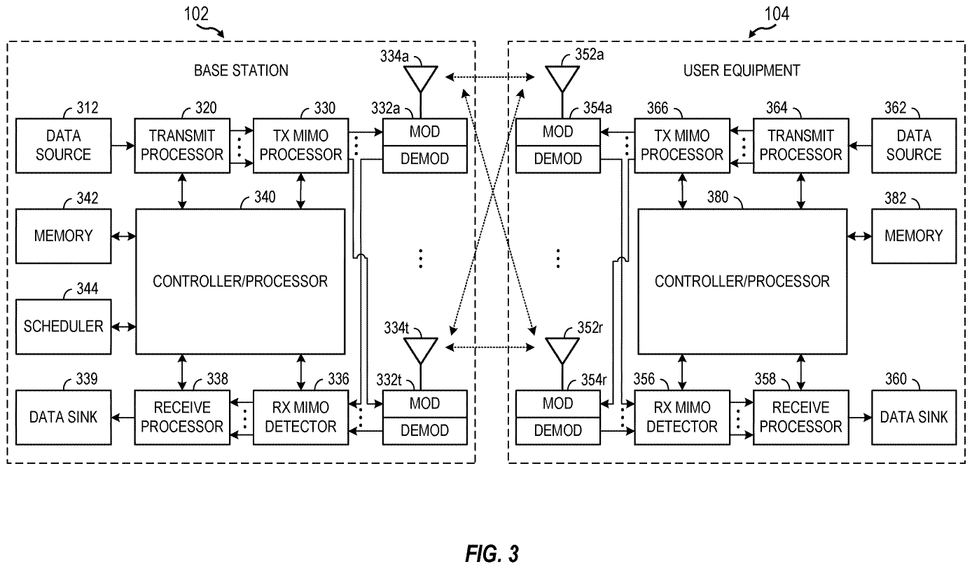

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

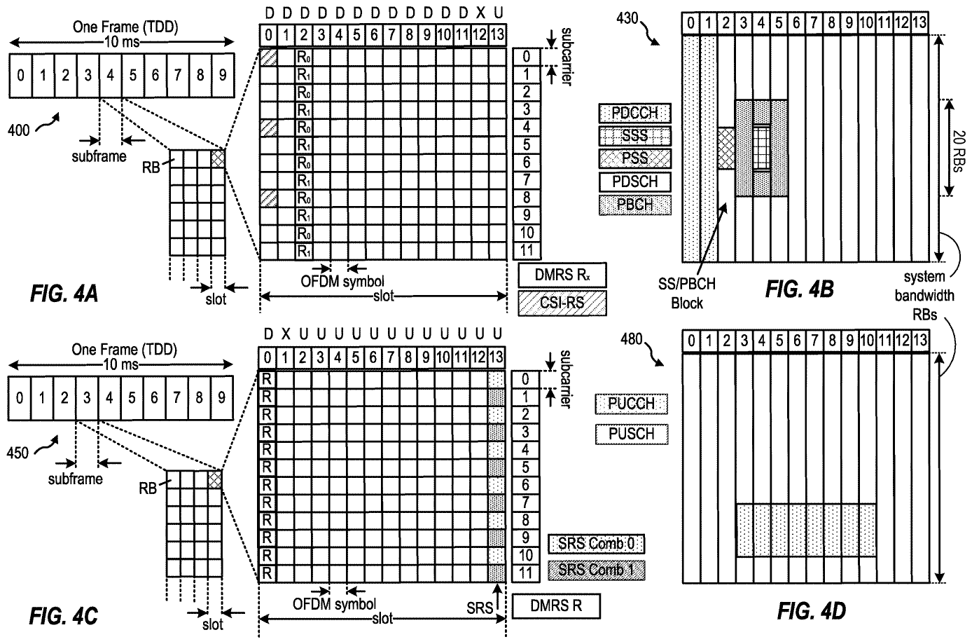

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ×}15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Rach Procedures

A random access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

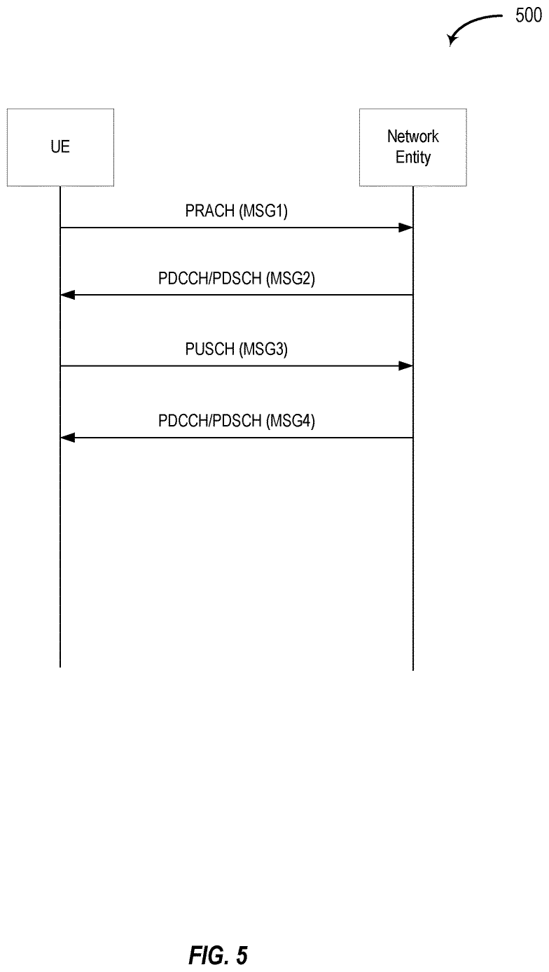

FIG. 5 is a timing (or “call-flow”) diagram 500 illustrating an example four-step RACH procedure, in accordance with certain aspects of the present disclosure. A first message (Msg1) may be sent from the UE to a network entity (e.g., a BS such as a gNB) on the physical random access channel (PRACH). In this case, Msg1 may only include a RACH preamble. The network entity may respond with a random access response (RAR) message (Msg2) which may include the identifier (ID) of the RACH preamble, a timing advance (TA), an uplink grant, cell radio network temporary identifier (C-RNTI), and a back off indicator. Msg2 may include a PDCCH communication including control information for a following communication on the PDSCH, as illustrated. In response to Msg2, Msg3 is transmitted from the UE to the network entity on the PUSCH. Msg3 may include one or more of a RRC connection request, a tracking area update request, a system information request, a positioning fix or positioning signal request, or a scheduling request. The network entity then responds with MSG 4 which may include a contention resolution message.

In some cases, to speed access, a two-step RACH procedure may be supported. As the name implies, the two-step RACH procedure may effectively “collapse” the four messages of the four-step RACH procedure into two messages.

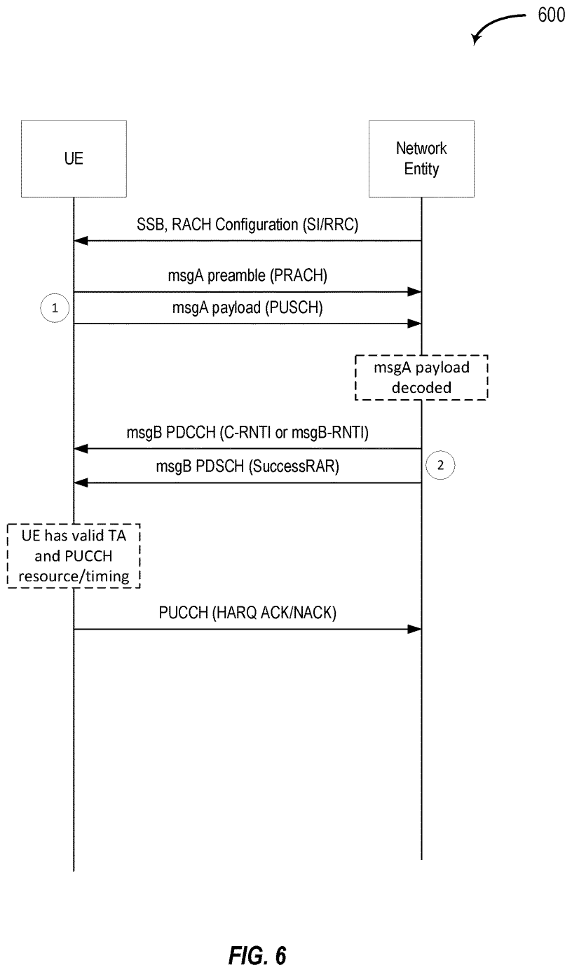

FIG. 6 is a call flow diagram 600 illustrating an example two-step RACH procedure, in accordance with certain aspects of the present disclosure. As illustrated, the UE may be configured with parameters, via system information (SI) and/or RRC signaling, for SSB monitoring and RACH procedure.

For the 2-step RACH procedure, a first enhanced message (msgA) may be sent from the UE to the network entity. In certain aspects, msgA includes some or all the information from Msg1 and Msg3 from the four-step RACH procedure, effectively combining Msg1 and Msg3. For example, msgA may include Msg1 and Msg3 multiplexed together using, for example, one of time-division multiplexing or frequency-division multiplexing. In certain aspects, msgA includes a RACH preamble for random access and a payload. The msgA payload, for example, may include the UE-ID and other signaling information (e.g., a buffer status report (BSR)) or a scheduling request (SR). The BS may respond with a random access response (RAR) message (msgB) which may effectively combine Msg2 and Msg4 described above. For example, msgB may include the ID of the RACH preamble, a timing advance (TA), a back off indicator, a contention resolution message, UL/DL grant, and transmit power control (TPC) commands.

In a two-step RACH procedure, the msgA may include a RACH preamble and a payload. In some cases, the RACH preamble and payload may be sent in a msgA transmission occasion.

The random access message (msgA) transmission occasion generally includes a msgA preamble occasion (for transmitting a preamble signal) and a msgA payload occasion for transmitting a PUSCH. The msgA preamble transmission generally involves:
(1) selection of a preamble sequence; and
(2) selection of a preamble occasion in time/frequency domain (for transmitting the selected preamble sequence).

The msgA payload transmission generally involves:
(1) construction of the random access message payload (DMRS/PUSCH); and
(2) selection of one or multiple PUSCH resource units (PRUs) in time/frequency domain to transmit this message (payload).

In some cases, a UE monitors SSB transmissions which are sent (by a gNB using different beams) and are associated with a finite set of time/frequency resources defining RACH occasions (ROs) and PRUs. Upon detecting an SSB, the UE may select an RO and one or more PRUs associated with that SSB for a Msg1/msgA transmission.

There are several benefits to a two-step RACH procedure, such as speed of access and the ability to send a relatively small amount of data without the overhead of a full four-step RACH procedure to establish a connection (when the four-step RACH messages may be larger than the payload).

The two-step RACH procedure can operate in any RRC state and any supported cell size. Networks that uses two-step RACH procedures can typically support contention-based random access (CBRA) transmission of messages (e.g., msgA) within a finite range of payload sizes and with a finite number of MCS levels.

After a UE has selected an SSB (beam), for that SS block there is a predefined one or more ROs with certain time and frequency offset and direction (e.g., specific to the selected SSB).

This SSB to RO association is used for the network (e.g., a gNB) to know which beam the UE has acquired and/or is using (generally referred to as beam establishment). One SSB may be associated with one or more ROs or more than one SSB may be associated with one RO. Association is typically performed in the frequency domain first, then in the time domain within a RACH slot, then in the time domain across RACH slots (e.g., beginning with lower SSB indexes). An association period is typically defined as a minimum number of RACH configuration periods, such that all (configured) SSB beams are mapped into ROs.

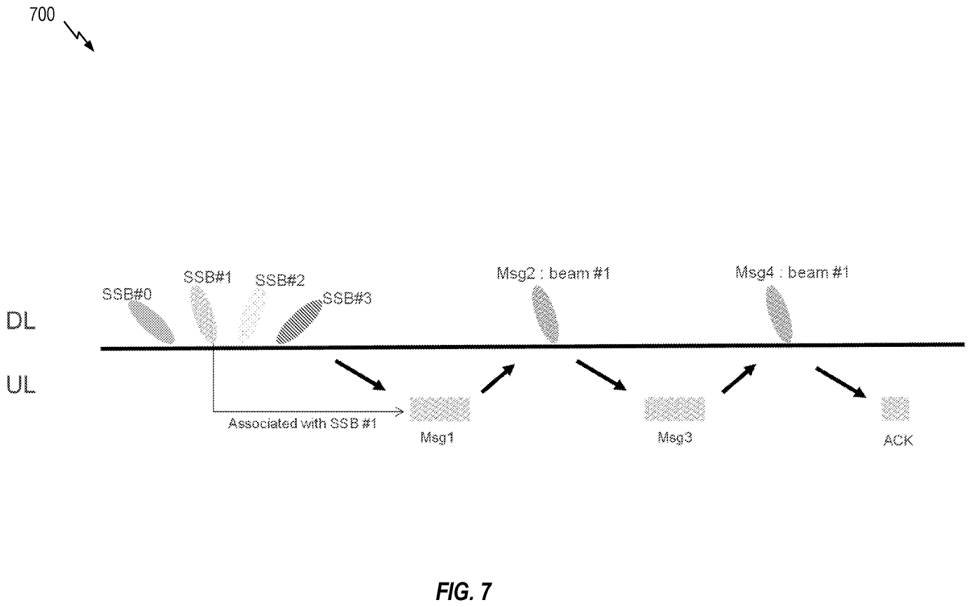

FIG. 7 depicts an example timeline 700 of PRACH transmission in a multi-beam system, according to aspects of the present disclosure. In the example timeline, an SSB to RO mapping may be configured by a SIB transmitted by a network entity (e.g., a gNB). A network entity transmits SSBs using differing beams. A UE, such as UE 104 shown in FIGS. 1 and 3, chooses the SSB #1 based on reference signal received power (RSRP) of the various SSBs. The UE then selects the PRACH resource that is associated with SSB #1. The UE transmits Msg1 (e.g., a PRACH) of a 4-step PRACH procedure using the spatial filter associated with SSB #1. As illustrated, if Msg1 is received by the network entity, the network entity will use the same beam for the transmission of the Msg2 PDCCH and/or PDSCH and the Msg4 PDCCH and/or PDSCH. The UE transmits the Msg3 PUSCH using the same spatial filter that the UE used to transmit the Msg1.

In typical communications systems, for a Type-1 (contention-based) random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB.

In typical communications systems, for a Type-1 random access procedure, or for a Type-2 (contention-free) random access procedure with a separate configuration of PRACH occasions from Type-1 random access procedures, if N<1, one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index

$$n \cdot {N}_{preamble}^{t otal} / N$$

where

$${N}_{preamble}^{total}$$

is provided by totalNumberOfRA-Preambles for Type-1 ramdom access procedures.

SS/PBCH block indexes provided by ssb-PositionsInBurst in SIB1 or in ServingCellConfigCommon are mapped to valid PRACH occasions in the following order:
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

In typical communications systems, an association period, starting from frame 0, for mapping SS/PBCH blocks to PRACH occasions is the smallest value in the set determined by the PRACH configuration period according Table 8.1-1 such that

$${N}_{Tx }^{SSB}$$

SS/PBCH blocks are mapped at least once to the PRACH occasions within the association period, where a UE obtains

$${N}_{Tx}^{S S B}$$

from the value of ssb-PositionsInBurst in SIB1 or in ServingCellConfigCommon. If after an integer number of SS/PBCH blocks to PRACH occasions mapping cycles within the association period there is a set of PRACH occasions or PRACH preambles that are not mapped to

$${N}_{T x}^{S S B} SS / PBCH blocks ,$$

SS/PBCH blocks, no SS/PBCH blocks are mapped to the set of PRACH occasions or PRACH preambles. An association pattern period includes one or more association periods and is determined so that a pattern between PRACH occasions and SS/PBCH blocks repeats at most every 160 msec. PRACH occasions not associated with SS/PBCH blocks after an integer number of association periods, if any, are not used for PRACH transmissions.

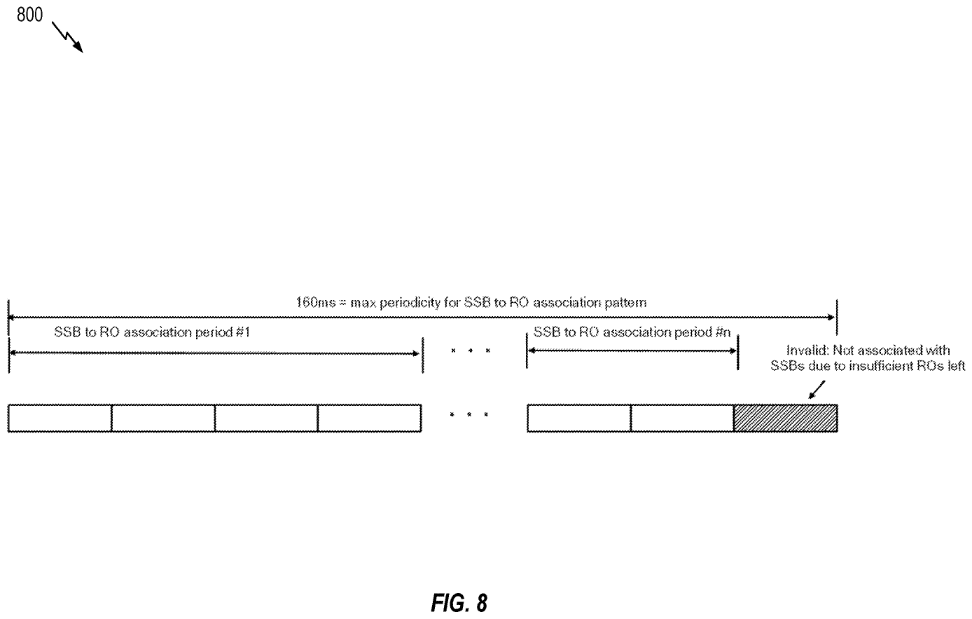

FIG. 8 depicts an example timeline 800 of an association pattern period, according to aspects of the present disclosure. In the example timeline, the association pattern period includes n association periods and repeats with a periodicity of 160 msec. As illustrated, some PRACH occasions are not associated with SS/PBCH blocks, are not used for PRACH transmissions, and are considered invalid ROs.

### Aspects Related to Frequency Hopping Considerations with Multiple Physical Random Access Channel Transmissions

According to aspects of the present disclosure, using frequency hopping when transmitting multiple PRACH transmissions (e.g., PRACH transmissions with repetition) may improve the probability that a network entity will successfully receive a PRACH transmission from a UE.

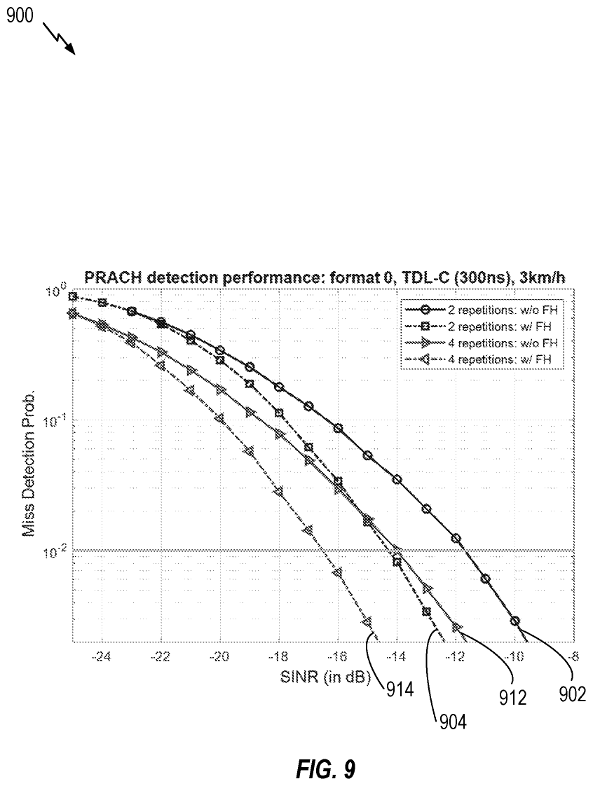

FIG. 9 is a graph 900 depicting PRACH detection performance for a network entity receiving PRACH transmission repetitions with and without frequency hopping, in accordance with aspects of the present disclosure. Curve 902 shows PRACH detection performance for a PRACH transmitted with two repetitions without using FH, and curve 904 shows PRACH detection performance for the PRACH transmitted with two repetitions while using FH. Similarly, curve 912 shows PRACH detection performance for a PRACH transmitted with four repetitions without using FH, and curve 914 shows PRACH detection performance for the PRACH transmitted with four repetitions while using FH. As illustrated, for a miss detection probability of 10⁻² (i.e., 1%), the two repetitions with FH (i.e., curve 904) can be transmitted with a signal-to-interference-and-noise ratio (SINR) that is approximately 2.5 dB lower than the two repetitions transmitted without FH (i.e., curve 902). Similarly, for the same miss detection probability of 10⁻², the four repetitions with FH (i.e., curve 914) can be transmitted with a signal-to-interference-and-noise ratio (SINR) that is approximately 2.5 dB lower than the four repetitions transmitted without FH (i.e., curve 912).

In aspects of the present disclosure, a UE may determine whether FH is enabled when transmitting PRACH messages with repetition based on configured values of SS/PBCH block indexes associated with one PRACH occasion (i.e., N, as described herein) and a number of ROs multiplexed in the frequency domain, also referred to herein as msg1-FDM. The UE may make the determination when configured to perform a four-step RACH procedure (see above with reference to FIG. 5) or a two-step RACH procedure (see above with reference to FIG. 6).

According to aspects of the present disclosure, if N<1 (i.e., multiple ROs are associated with one SSB) and msg1-FDM >1 (i.e., multiple ROs are multiplexed in frequency), then a UE determines that FH is enabled for transmitting PRACH messages with repetition. Otherwise, FH is not enabled for transmitting PRACH messages with repetition, because there are not different frequency locations for the ROs associated with the same SSB.

In aspects of the present disclosure, an explicit flag or configured parameter is not transmitted by a network entity to enable FH for transmitting PRACH messages with repetition, which is unlike typical communication systems.

### Example Operations of Entities in a Communications Network

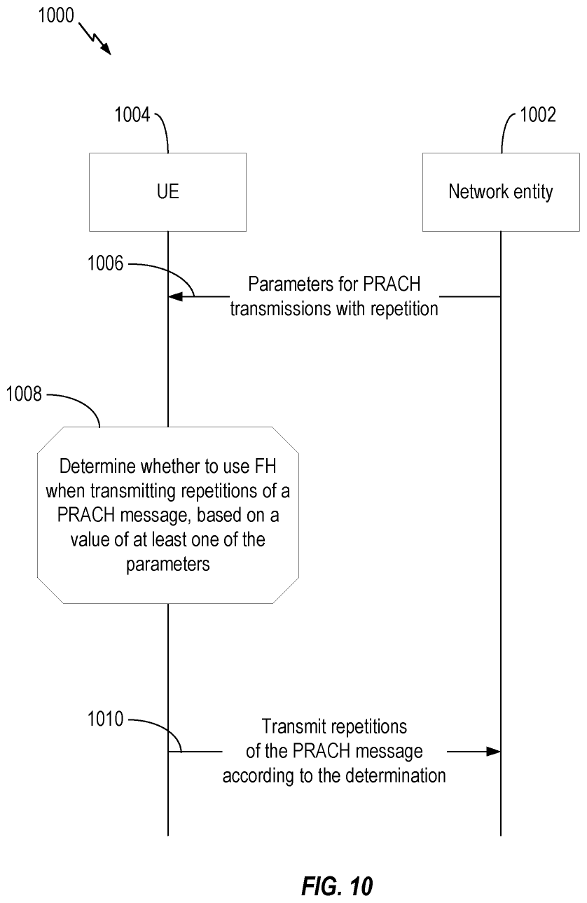

FIG. 10 depicts a process flow 1000 for communications in a network between a network entity 1002 and a user equipment (UE) 1004. In some aspects, the network entity 1002 may be an example of the BS 102 depicted and described with respect to FIGS. 1 and 3 or a disaggregated base station depicted and described with respect to FIG. 2. Similarly, the UE 1004 may be an example of UE 104 depicted and described with respect to FIGS. 1 and 3. However, in other aspects, UE 104 may be another type of wireless communications device and BS 102 may be another type of network entity or network node, such as those described herein.

The process flow 1000 begins at 1006 with the UE receiving configuration information indicating one or more parameters configuring the UE for physical random access channel (PRACH) message transmissions with repetition. For example, the UE may receive a configuration setting N to ½, and msg1-FDM to 2.

At 1008, the UE determines whether to use frequency hopping when transmitting repetitions of a PRACH message, based on a value of at least one of the parameters. Continuing the example from above, the UE determines to use frequency hopping when transmitting repetitions of a PRACH message, based on N being ½ and msg1-FDM being 2.

At 1010, the UE transmits repetitions of the PRACH message in accordance with the determination.

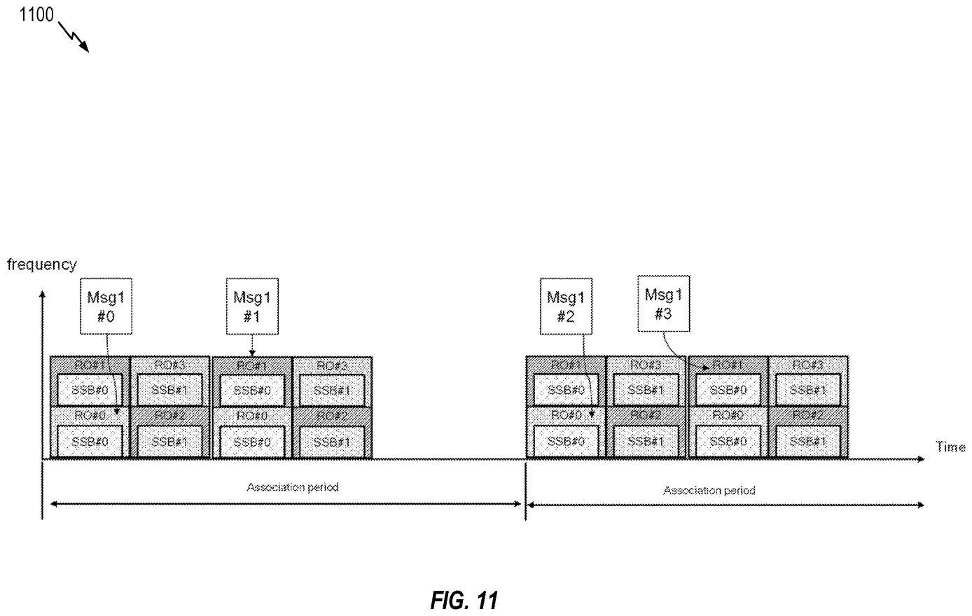

FIG. 11 shows an example timeline 1100 of a UE (e.g., UE 104 depicted and described with respect to FIGS. 1 and 3) transmitting repetitions of a PRACH message with frequency hopping with a single beam, in accordance with aspects of the present disclosure. In the illustrated timeline, the UE has received a configuration setting N to ½, and msg1-FDM to 2. The network transmits two SSBs, labeled SSB #0 and SSB #1, and thus

$${N}_{T x}^{S S B}$$

is equal to 2. The UE is configured to transmit four repetitions of a PRACH message. There are two cycles of mapping SS/PBCH block indexes to PRACH occasions within each association period. As illustrated, the UE may transmit a first repetition of Msg1 (labeled Msg1 #0) in the frequency resources of RO #0 and using the spatial filter associated with SSB #0. As N is ½, another set of ROs are associated with the SSBs in the same association period. In this other set of ROs, two ROs, RO #0 and RO #1, are multiplexed in the frequency domain, and thus when the UE transmits the second repetition of Msg1 (labeled Msg1 #1), the UE transmits this repetition with frequency hopping by transmitting this repetition on the frequency resources of RO #1 and using the spatial filter associated with SSB #0. Similarly, in the next association period, the UE transmits the third repetition (labeled Msg1 #2) in the frequency resources of RO #0 and then transmits the fourth repetition (labeled Msg1 #3) in the frequency resources of RO #1.

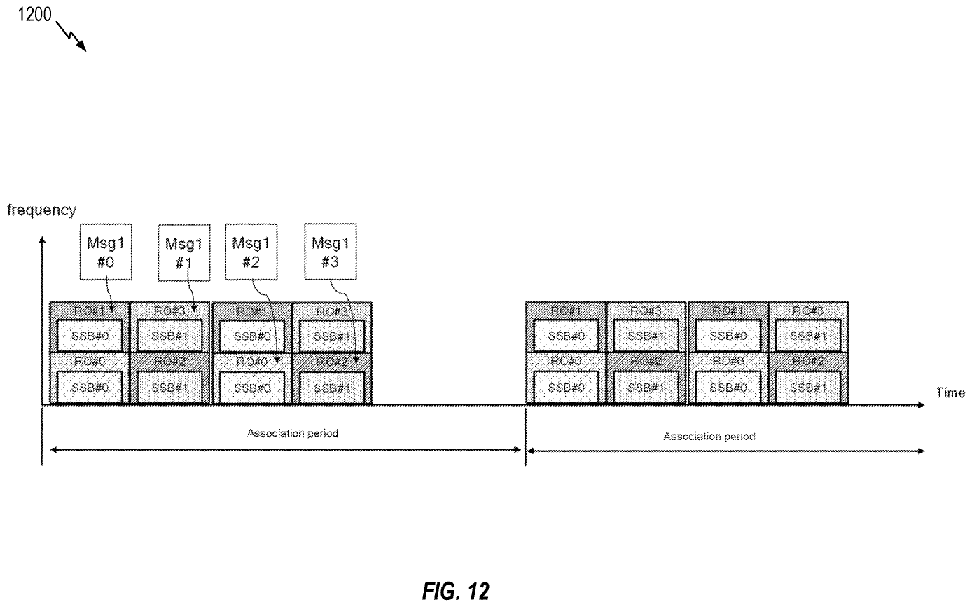

FIG. 12 shows an example timeline 1200 of a UE (e.g., UE 104 depicted and described with respect to FIGS. 1 and 3) transmitting repetitions of a PRACH message with frequency hopping with different beams, in accordance with aspects of the present disclosure. In the illustrated timeline, the UE has received a configuration setting N to ½, and msg1-FDM to 2. The network transmits two SSBs, labeled SSB #0 and SSB #1, and thus

$${N}_{T x}^{S S B}$$

is equal to 2. The UE is configured to transmit four repetitions of a PRACH message over two beams. There are two cycles of mapping SS/PBCH block indexes to PRACH occasions within each association period. As illustrated, the UE may transmit a first repetition of Msg1 (labeled Msg1 #0) in the frequency resources of RO #1 and using the spatial filter associated with SSB #0. The UE then transmits the second repetition of Msg1 (labeled Msg1 #1) in the frequency resources of RO #3 and using the spatial filter associated with SSB #1. As N is ½, another set of ROs are associated with the SSBs in the same association period. In this other set of ROs, two ROs, RO #0 and RO #1, are multiplexed in the frequency domain, and thus when the UE transmits the third repetition of Msg1 (labeled Msg1 #2), the UE transmits this repetition with frequency hopping by transmitting this repetition on the frequency resources of RO #0 and using the spatial filter associated with SSB #0. The UE transmits the fourth repetition (labeled Msg1 #3) with frequency hopping by transmitting this repetition in the frequency resources of RO #2and using the spatial filter associated with SSB #1. Thus, each of the repetitions of a PRACH message transmitted on a beam are transmitted on a different frequency (i.e., with frequency hopping) as the other repetition on that beam. Because the UE transmits the configured four repetitions of Msg1 in the first association period, the UE does not transmit any repetitions of Msg1 in the second association period.

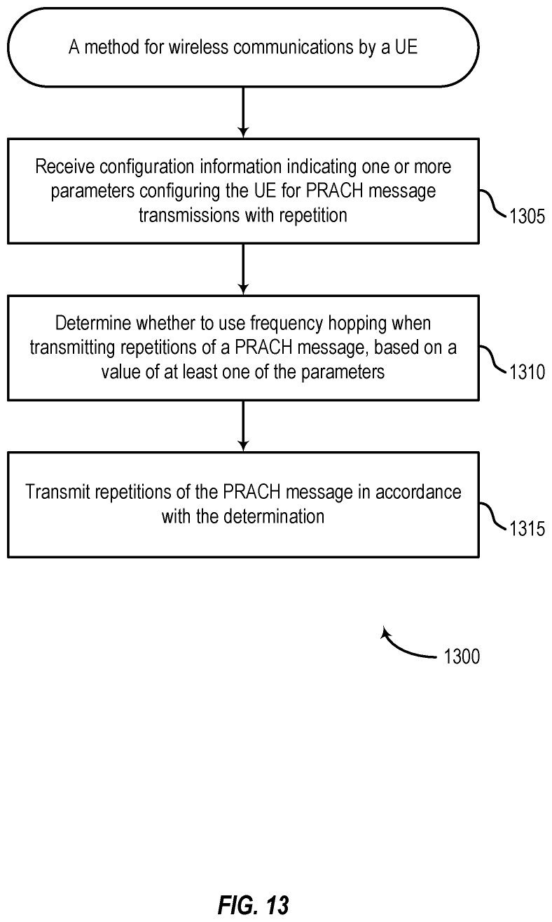

FIG. 13 shows an example of a method 1300 of wireless communication by a UE, such as a UE 104 of FIGS. 1 and 3.

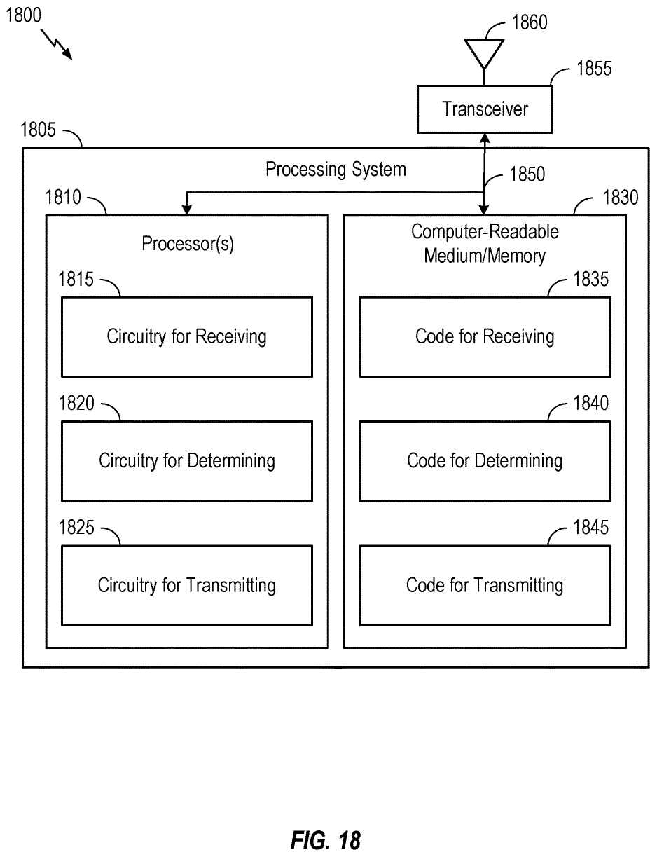

Method 1300 begins at step 1305 with receiving configuration information indicating one or more parameters configuring the UE for PRACH message transmissions with repetition. In some cases, the operations of this step refer to, or may be performed by, circuitry for receiving and/or code for receiving as described with reference to FIG. 18.

Method 1300 then proceeds to step 1310 with determining whether to use frequency hopping when transmitting repetitions of a PRACH message, based on a value of at least one of the parameters. In some cases, the operations of this step refer to, or may be performed by, circuitry for determining and/or code for determining as described with reference to FIG. 18.

Method 1300 then proceeds to step 1315 with transmitting repetitions of the PRACH message in accordance with the determination. In some cases, the operations of this step refer to, or may be performed by, circuitry for transmitting and/or code for transmitting as described with reference to FIG. 18.

In some aspects, the one or more parameters comprise at least one of: a number, N, of SSB indexes associated with one RO, and a number of ROs multiplexed in a frequency domain.

In some aspects, the determination is to use frequency hopping when transmitting repetitions of the PRACH message when N is less than one and the number of ROs multiplexed in the frequency domain is greater than one.

In some aspects, the configuration information maps a repetition of the PRACH message to an invalid RO; and the UE skips the repetition, postpones the repetition, or transmits the repetition, based on the determination.

In some aspects, the determination is to use frequency hopping when transmitting repetitions of the PRACH message and the UE transmits the repetition in a valid RO that is frequency domain multiplexed with an invalid RO.

In one aspect, method 1300, or any aspect related to it, may be performed by an apparatus, such as communications device 1800 of FIG. 18, which includes various components operable, configured, or adapted to perform the method 1300. Communications device 1800 is described below in further detail.

Note that FIG. 13 is just one example of a method, and other methods including fewer, additional, or alternative steps are possible consistent with this disclosure.

### Aspects Related to Frequency Hopping and Invalid Random Access Channel Occasions

In some aspects of the present disclosure, a PRACH repetition may be mapped into an invalid RO. When a PRACH repetition is mapped into an invalid RO in a system in which frequency hopping is not supported, the UE may skip transmitting the PRACH repetition entirely or postpone transmitting the PRACH repetition until the next valid RO.

According to aspects of the present disclosure, when a PRACH repetition is mapped into an invalid RO in a system in which frequency hopping is enabled, the UE may transmit the PRACH repetition on frequency resources of a RO that is frequency domain multiplexed with the invalid RO instead of skipping or postponing the PRACH repetition transmission.

In aspects of the present disclosure, a UE may determine whether to skip, postpone, or transmit a repetition that is mapped to an invalid RO, based on whether the UE is configured to use frequency hopping when transmitting repetitions of a PRACH message.

### Example Operations of Entities in a Communications Network

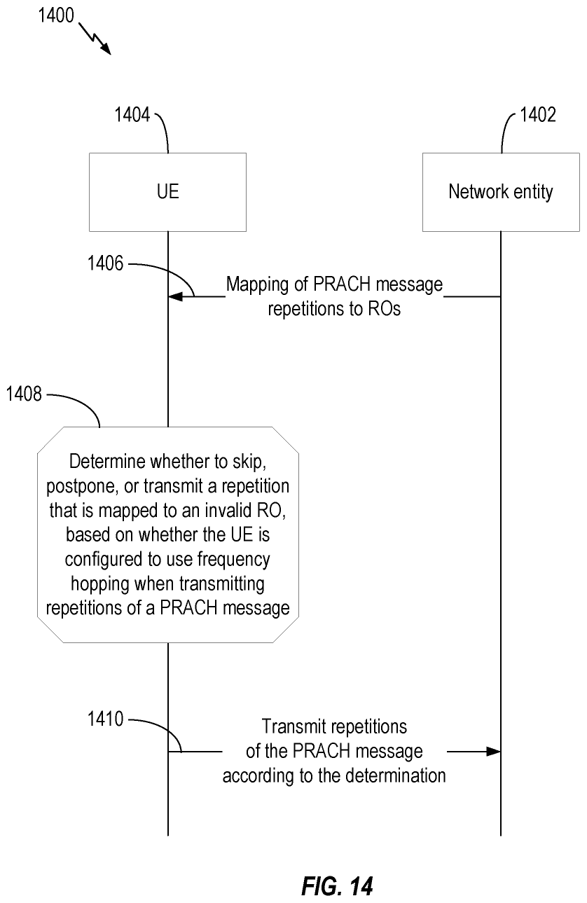

FIG. 14 depicts a process flow 1400 for communications in a network between a network entity 1402 and a user equipment (UE) 1404. In some aspects, the network entity 1402 may be an example of the BS 102 depicted and described with respect to FIGS. 1 and 3 or a disaggregated base station depicted and described with respect to FIG. 2. Similarly, the UE 1404 may be an example of UE 104 depicted and described with respect to FIGS. 1 and 3. However, in other aspects, UE 104 may be another type of wireless communications device and BS 102 may be another type of network entity or network node, such as those described herein.

The process flow 1400 begins at 1406 with the UE receiving configuration information that maps repetitions of a PRACH message to ROs. For example, the UE may receive a configuration mapping repetitions of a PRACH message to ROs with frequency hopping.

At 1408, the UE determines whether to skip, postpone, or transmit a repetition that is mapped to an invalid RO, based on whether the UE is configured to use frequency hopping when transmitting repetitions of a PRACH message. Continuing the example from above, the UE determines to use transmit a repetition that is mapped to an invalid RO based on the UE being configured to use frequency hopping when transmitting repetitions of a PRACH message.

At 1410, the UE transmits repetitions of the PRACH message in accordance with the determination. Continuing the example from above, the UE transmits the repetition that was mapped to an invalid RO in a valid RO that is frequency domain multiplexed with the invalid RO.

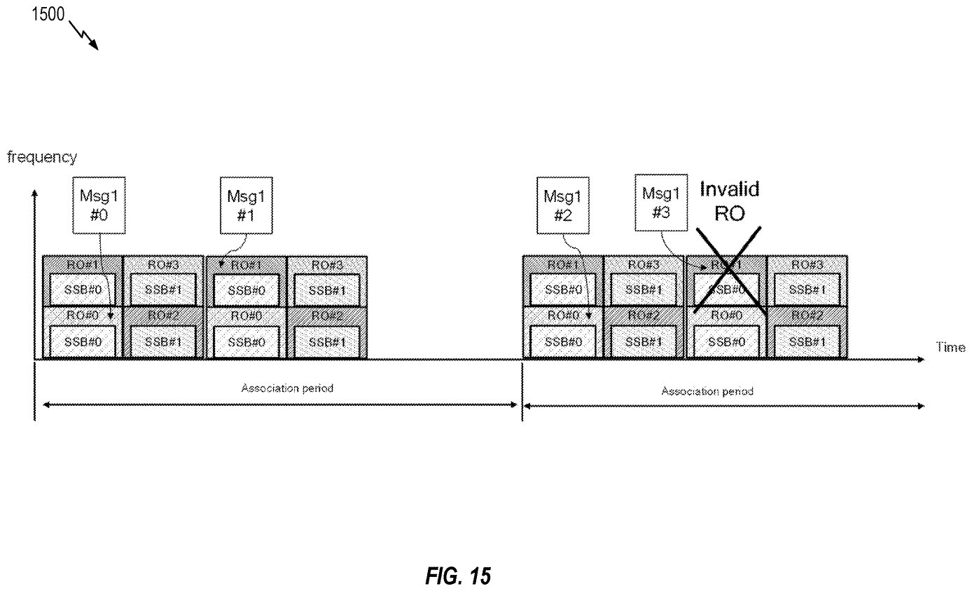

FIG. 15 shows an example timeline 1500 of a UE (e.g., UE 104 depicted and described with respect to FIGS. 1 and 3) transmitting repetitions of a PRACH message with frequency hopping with a single beam, in accordance with aspects of the present disclosure. In the illustrated timeline, the UE has received a configuration setting N to ½, and msg1-FDM to 2. The network transmits two SSBs, labeled SSB #0 and SSB #1, and thus

$${N}_{T x}^{S S B}$$

is equal to 2. The UE is configured to transmit four repetitions of a PRACH message. In the illustrated timeline, the fourth repetition (labeled Msg1 #3) is mapped to the invalid RO, RO #1, in the second association period. According to aspects of the present disclosure, the UE determines to transmit the fourth repetition, based on the UE being configured to use frequency hopping when transmitting repetitions of a PRACH message.

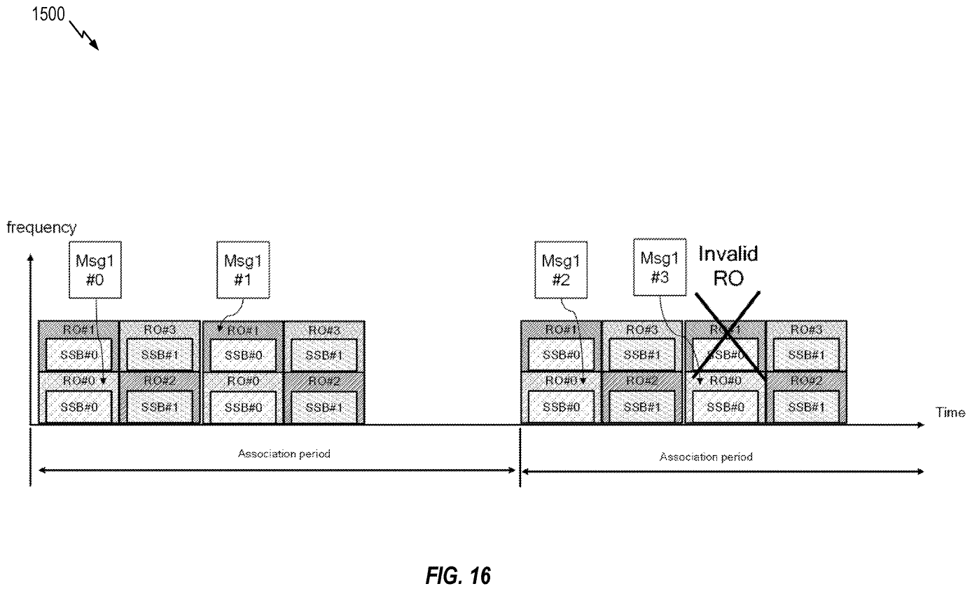

FIG. 16 shows the same example timeline 1500 as shown in FIG. 15, except the transmission of the fourth repetition of the PRACH message is illustrated. In the illustrated timeline, the UE transmits the fourth repetition (labeled Msg1 #3), which was mapped to the invalid RO, in the valid RO, RO #0, that is frequency domain multiplexed with the invalid RO in the second association period.

### Example Operations of User Equipment

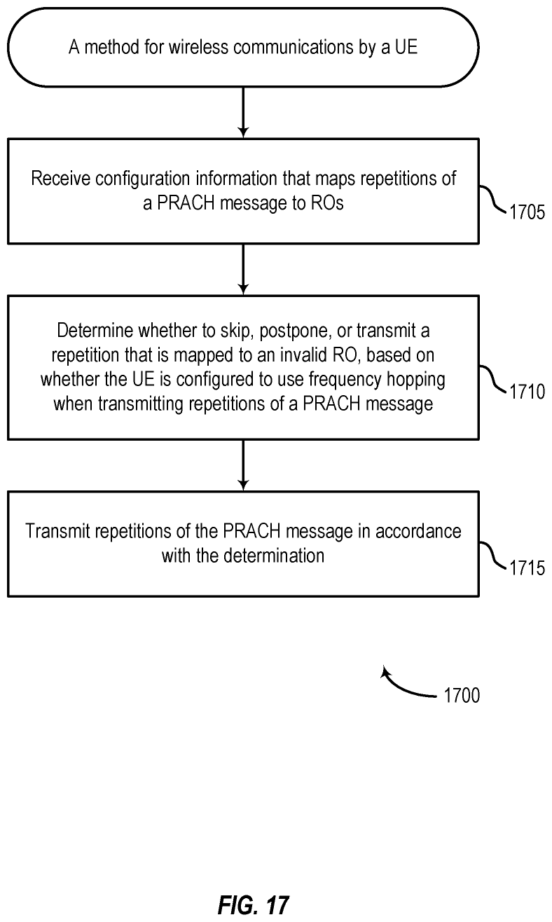

FIG. 17 shows an example of a method 1700 of wireless communication by a UE, such as a UE 104 of FIGS. 1 and 3.

Method 1700 begins at step 1705 with receiving configuration information that maps repetitions of a PRACH message to ROs. In some cases, the operations of this step refer to, or may be performed by, circuitry for receiving and/or code for receiving as described with reference to FIG. 18.

Method 1700 then proceeds to step 1710 with determining whether to skip, postpone, or transmit a repetition that is mapped to an invalid RO, based on whether the UE is configured to use frequency hopping when transmitting repetitions of a PRACH message. In some cases, the operations of this step refer to, or may be performed by, circuitry for determining and/or code for determining as described with reference to FIG. 18.

Method 1700 then proceeds to step 1715 with transmitting repetitions of the PRACH message in accordance with the determination. In some cases, the operations of this step refer to, or may be performed by, circuitry for transmitting and/or code for transmitting as described with reference to FIG. 18.

In some aspects, the UE is configured to use frequency hopping when transmitting repetitions of the PRACH message; and the determination comprises determining to transmit the repetition.

In some aspects, the method 1700 further includes transmitting the repetition in a valid RO that is frequency domain multiplexed with the invalid RO. In some cases, the operations of this step refer to, or may be performed by, circuitry for transmitting and/or code for transmitting as described with reference to FIG. 18.

In some aspects, two or more valid ROs are frequency domain multiplexed with the invalid RO; and transmitting the repetition comprises transmitting the repetition based on an RO index of the valid RO.

In some aspects, transmitting the repetition comprises transmitting the repetition during the valid RO with a highest RO index or a lowest RO index, of the two or more valid ROs.

In some aspects, two or more valid ROs are frequency domain multiplexed with the invalid RO.

In some aspects, the method 1700 further includes receiving an indication from a network entity of which of the two or more valid ROs is preferred for transmission of the repetition, wherein transmitting the repetition comprises transmitting the repetition in the valid RO preferred for transmission of the repetition. In some cases, the operations of this step refer to, or may be performed by, circuitry for receiving and/or code for receiving as described with reference to FIG. 18.

In some aspects, the method 1700 further includes receiving an explicit indication that the UE is configured to use frequency hopping when transmitting repetitions of the PRACH message. In some cases, the operations of this step refer to, or may be performed by, circuitry for receiving and/or code for receiving as described with reference to FIG. 18.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to the transceiver 1855 (e.g., a transmitter and/or a receiver). The transceiver 1855 is configured to transmit and receive signals for the communications device 1800 via the antenna 1860, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, cause the one or more processors 1810 to perform the method 1300 described with respect to FIG. 13, or any aspect related to it; and the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1830 stores code (e.g., executable instructions), such as code for receiving 1835, code for determining 1840, and code for transmitting 1845. Processing of the code for receiving 1835, code for determining 1840, and code for transmitting 1845 may cause the communications device 1800 to perform the method 1300 described with respect to FIG. 13, or any aspect related to it; and the method 1700 described with respect to FIG. 17, or any aspect related to it.

The one or more processors 1810 include circuitry configured to implement (e.g., execute) the code stored in the computer-readable medium/memory 1830, including circuitry such as circuitry for receiving 1815, circuitry for determining 1820, and circuitry for transmitting 1825. Processing with circuitry for receiving 1815, circuitry for determining 1820, and circuitry for transmitting 1825 may cause the communications device 1800 to perform the method 1300 described with respect to FIG. 13, or any aspect related to it; and the method 1700 described with respect to FIG. 17, or any aspect related to it.

Various components of the communications device 1800 may provide means for performing the method 1300 described with respect to FIG. 13, or any aspect related to it; and the method 1700 described with respect to FIG. 17, or any aspect related to it. For example, means for transmitting, sending, or outputting for transmission may include transceivers 354 and/or antenna(s) 352 of the UE 104 illustrated in FIG. 3 and/or the transceiver 1855 and the antenna 1860 of the communications device 1800 in FIG. 18. Means for receiving or obtaining may include transceivers 354 and/or antenna(s) 352 of the UE 104 illustrated in FIG. 3 and/or the transceiver 1855 and the antenna 1860 of the communications device 1800 in FIG. 18.

### Example Clauses

Implementation examples are described in the following numbered clauses:

Clause 1: A method for wireless communications by a UE, comprising: receiving configuration information indicating one or more parameters configuring the UE for PRACH message transmissions with repetition; determining whether to use frequency hopping when transmitting repetitions of a PRACH message, based on a value of at least one of the parameters; and transmitting repetitions of the PRACH message in accordance with the determination.

Clause 2: The method of Clause 1, wherein the one or more parameters comprise at least one of: a number, N, of SSB indexes associated with one RO, and a number of ROs multiplexed in a frequency domain.

Clause 3: The method of Clause 2, wherein: the determination is to use frequency hopping when transmitting repetitions of the PRACH message; N is less than one; and the number of ROs multiplexed in the frequency domain is greater than one.

Clause 4: The method of any one of Clauses 1-3, wherein: the configuration information maps a repetition of the PRACH message to an invalid RO; and the UE skips the repetition, postpones the repetition, or transmits the repetition, based on the determination.

Clause 5: The method of Clause 4, wherein: the determination is to use frequency hopping when transmitting repetitions of the PRACH message; and the UE transmits the repetition in a valid RO that is frequency domain multiplexed with the invalid RO.

Clause 6: A method for wireless communications by a UE, comprising: receiving configuration information that maps repetitions of a PRACH message to ROs; determining whether to skip, postpone, or transmit a repetition that is mapped to an invalid RO, based on whether the UE is configured to use frequency hopping when transmitting repetitions of a PRACH message; and transmitting repetitions of the PRACH message in accordance with the determination.

Clause 7: The method of Clause 6, wherein: the UE is configured to use frequency hopping when transmitting repetitions of the PRACH message; the determination comprises determining to transmit the repetition; and the method further comprises: transmitting the repetition in a valid RO that is frequency domain multiplexed with the invalid RO.

Clause 8: The method of Clause 7, wherein: two or more valid ROs are frequency domain multiplexed with the invalid RO; and transmitting the repetition comprises transmitting the repetition based on an RO index of the valid RO.

Clause 9: The method of Clause 8, wherein: transmitting the repetition comprises transmitting the repetition during the valid RO with a highest RO index or a lowest RO index, of the two or more valid ROs.

Clause 10: The method of Clause 7, wherein: two or more valid ROs are frequency domain multiplexed with the invalid RO; and the method further comprises: receiving an indication from a network entity of which of the two or more valid ROs is preferred for transmission of the repetition, wherein transmitting the repetition comprises transmitting the repetition in the valid RO preferred for transmission of the repetition.

Clause 11: The method of any one of Clauses 6-10, further comprising: receiving an explicit indication that the UE is configured to use frequency hopping when transmitting repetitions of the PRACH message.

Clause 12: An apparatus, comprising: a memory comprising executable instructions; and a processor configured to execute the executable instructions and cause the apparatus to perform a method in accordance with any one of Clauses 1-11.

Clause 13: An apparatus, comprising means for performing a method in accordance with any one of Clauses 1-11.

Clause 14: A non-transitory computer-readable medium comprising executable instructions that, when executed by a processor of an apparatus, cause the apparatus to perform a method in accordance with any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) configured for wireless communications, comprising:
a memory comprising computer-executable instructions; and
a processor configured to execute the computer-executable instructions and cause the UE to:
receive configuration information indicating one or more parameters configuring the UE for physical random access channel (PRACH) message transmissions with repetition;
determine whether to use frequency hopping when transmitting repetitions of a PRACH message, based on a value of at least one of the parameters; and
transmit repetitions of the PRACH message in accordance with the determination.

2. The UE of claim 1, wherein the one or more parameters comprise at least one of:
a number, N, of synchronization signal block (SSB) indexes associated with one random access channel (RACH) occasion (RO), and
a number of ROs multiplexed in a frequency domain.

3. The UE of claim 2, wherein the processor is configured to execute the computer-executable instructions to further cause the UE to determine to use frequency hopping when transmitting repetitions of the PRACH message when:
N is less than one; and
the number of ROs multiplexed in the frequency domain is greater than one.

4. The UE of claim 1, wherein the processor is configured to execute the computer-executable instructions to further cause the UE to skip the repetition, postpone the repetition, or transmit the repetition, based on the determination, when the configuration information maps a repetition of the PRACH message to an invalid random access channel (RACH) occasion (RO).

5. The UE of claim 4, wherein the processor is configured to execute the computer-executable instructions to further cause the UE to transmit the repetition in a valid RO that is frequency domain multiplexed with the invalid RO, when the processor causes the UE to determine to use frequency hopping when transmitting repetitions of the PRACH message.

6. A user equipment (UE) configured for wireless communications, comprising:
a memory comprising computer-executable instructions; and
a processor configured to execute the computer-executable instructions and cause the UE to:
receive configuration information that maps repetitions of a physical random access channel (PRACH) message to random access channel (RACH) occasions (ROs) ;
determine whether to skip, postpone, or transmit a repetition that is mapped to an invalid RO, based on whether the UE is configured to use frequency hopping when transmitting repetitions of a PRACH message; and
transmit repetitions of the PRACH message in accordance with the determination.

7. The UE of claim 6, wherein the processor is configured to execute the computer-executable instructions to further cause the UE to:
when the UE is configured to use frequency hopping when transmitting repetitions of the PRACH message:
determine to transmit the repetition; and
transmit the repetition in a valid RO that is frequency domain multiplexed with the invalid RO.

8. The UE of claim 7, wherein the processor is configured to execute the computer-executable instructions to further cause the UE to transmit the repetition based on an RO index of the valid RO when two or more valid ROs are frequency domain multiplexed with the invalid RO.

9. The UE of claim 8, wherein the processor is configured to execute the computer-executable instructions to further cause the UE to transmit the repetition during the valid RO with a highest RO index or a lowest RO index, of the two or more valid ROs.

10. The UE of claim 7, wherein the processor is configured to execute the computer-executable instructions to further cause the UE, when two or more valid ROs are frequency domain multiplexed with the invalid RO, to:
receive an indication from a network entity of which of the two or more valid ROs is preferred for transmission of the repetition; and
transmit the repetition in the valid RO preferred for transmission of the repetition.

11. The UE of claim 6, wherein the processor is configured to execute the computer-executable instructions to further cause the UE to:
receive an explicit indication that the UE is configured to use frequency hopping when transmitting repetitions of the PRACH message.

12. A method for wireless communications by a user equipment (UE), comprising:
receiving configuration information indicating one or more parameters configuring the UE for physical random access channel (PRACH) message transmissions with repetition;
determining whether to use frequency hopping when transmitting repetitions of a PRACH message, based on a value of at least one of the parameters; and
transmitting repetitions of the PRACH message in accordance with the determination.

13. The method of claim 12, wherein the one or more parameters comprise at least one of:
a number, N, of synchronization signal block (SSB) indexes associated with one random access channel (RACH) occasion (RO), and
a number of ROs multiplexed in a frequency domain.

14. The method of claim 13, wherein:
the determination is to use frequency hopping when transmitting repetitions of the PRACH message;
N is less than one; and
the number of ROs multiplexed in the frequency domain is greater than one.

15. The method of claim 12, wherein:
the configuration information maps a repetition of the PRACH message to an invalid random access channel (RACH) occasion (RO); and
the UE skips the repetition, postpones the repetition, or transmits the repetition, based on the determination.

16. The method of claim 15, wherein:
the determination is to use frequency hopping when transmitting repetitions of the PRACH message; and
the UE transmits the repetition in a valid RO that is frequency domain multiplexed with the invalid RO.

17. A method for wireless communications by a user equipment (UE), comprising:
receiving configuration information that maps repetitions of a physical random access channel (PRACH) message to random access channel (RACH) occasions (ROs);
determining whether to skip, postpone, or transmit a repetition that is mapped to an invalid RO, based on whether the UE is configured to use frequency hopping when transmitting repetitions of a PRACH message; and
transmitting repetitions of the PRACH message in accordance with the determination.

18. The method of claim 17, wherein:
the UE is configured to use frequency hopping when transmitting repetitions of the PRACH message;
the determination comprises determining to transmit the repetition; and the method further comprises:
transmitting the repetition in a valid RO that is frequency domain multiplexed with the invalid RO.

19. The method of claim 18, wherein:
two or more valid ROs are frequency domain multiplexed with the invalid RO; and
transmitting the repetition comprises transmitting the repetition based on an RO index of the valid RO.

20. The method of claim 19, wherein transmitting the repetition comprises transmitting the repetition during the valid RO with a highest RO index or a lowest RO index, of the two or more valid ROs.

21-22. (canceled)
